(19) United States
(12) Patent Application Publication
(10) Pub. No.: US 2007/0242168 A1
(43) Pub. Date: Oct. 18, 2007

(54) Method and Arrangement for Presenting a Virtual Landscape

(76) Inventor: Ritva Laijoki-Puska, Espoo (FI)

Correspondence Address: BIRCH STEWART KOLASCH & BIRCH, PO BOX 747, FALLS CHURCH, VA, 22040-0747, US

(21) Appl. No.: 11/579,951

(22) PCT Filed: May 11, 2005
(86) PCT No.: PCT/FI05/50154

§ 371 Date: May 14, 2007

(30) Foreign Application Priority Data
May 11, 2004 (FI) 20040667

(51) Int. Cl. G03B 21/00

(52) U.S. Cl. 348/744; 348/E09.025

(57) ABSTRACT

The subject of the invention is a method for displaying a three-dimensional virtual scenery where consecutive, visible scenery elements (5, 5a, 5b, 5b′, 5b″), visible to the spectator (1) as a three-dimensional impression, are produced in consecutive, at least partially transparent planes. The scope of the invention also includes an arrangement containing several consecutive, at least partially transparent display or image planes (4, 4a, 4b, 4b′, 4c, 4c′, 4d, 4d′), as well as the devices (7, 7′, 8) for producing the scenery elements in visible form on these planes.

The subject of the invention is a method according to the preamble of patent claim 1, and an arrangement according to the preamble of patent claim 5, for displaying a three-dimensional virtual scenery to one or more spectators.

Different arrangements of prior art are already known for displaying a virtual scenery to a spectator. One such arrangement is a scenery made of stage decorations in theatres where several decorative elements depicting concrete elements of landscape, such as trees, rooms or even clouds, normally formed in an artificial and often in an allusive manner only, are physically placed on the stage at different distances from the spectators. In such cases, the spectator often forms a rather diagrammatic mental image of a three-dimensional virtual world, i.e. of the space where the performance then takes place.

Another, similar, method of presentation is related to the old technique of animated cartoons—nowadays in practice implemented using other methods such as digital techniques—where the background of a scene, in particular, is formed using several decorative elements laid out “on top of each other” using photographic techniques and often moving in relation to one and other.

Other types of methods for displaying a virtual scenery, i.e. a scenery different from physical reality, have been presented over the years, their leading principle being the fact that the different elements actually physically exist. Thus, only the total picture formed by the different elements was a virtual one. Such a physical implementation has, among other things, the drawback that modifying individual elements is rather difficult. Further, the physical elements normally require supporting structures for maintaining their correct positioning.

As such, certain prior art arrangements for displaying a virtual scenery are also known where the virtual reality seen by the spectator is only formed in the spectator's brain. This category can be deemed to include different stereoscopic picture shows where the spectator wears special goggles to see different pictures from different sources with both of his/her eyes, and these pictures are then combined into one three-dimensional image in the spectator's brain. Nowadays, such virtual shows can also be implemented using digital technology, but in order to present the spectators with a three-dimensional sensation, special projection equipment is required for projecting the differing images either straight at the eyes of spectators, or to a device viewed separately by both eyes.

The goal of this invention is a means that allows disposing of the physically produced elements on the one hand, and the viewing devices held by the spectators on the other. Therefore, the objective of the invention is to replace such elements with totally virtual elements providing the spectators with a three-dimensional image without any dedicated viewing devices.

In order to achieve these goals, a method according to the invention was developed, together with a corresponding arrangement, the characteristics of which are stated in the enclosed patent claims. Therefore, the method according to the invention is characterized in that consecutive, visible scenery elements are formed on consecutive, at least partially transparent planes and/or spaces between these planes so that these series of images are visible to the spectator as a three-dimensional expression of a virtual scenery.

Similarly, the arrangement according to the invention is characterized in that the composition has several, consecutively arranged and at least partially transparent display or image planes so that the system includes equipment for producing the scenery elements in a visual form on these planes and/or between them.

Certain preferable embodiments of the invention are presented below in more detail by way of example and making reference to the enclosed figures, where:

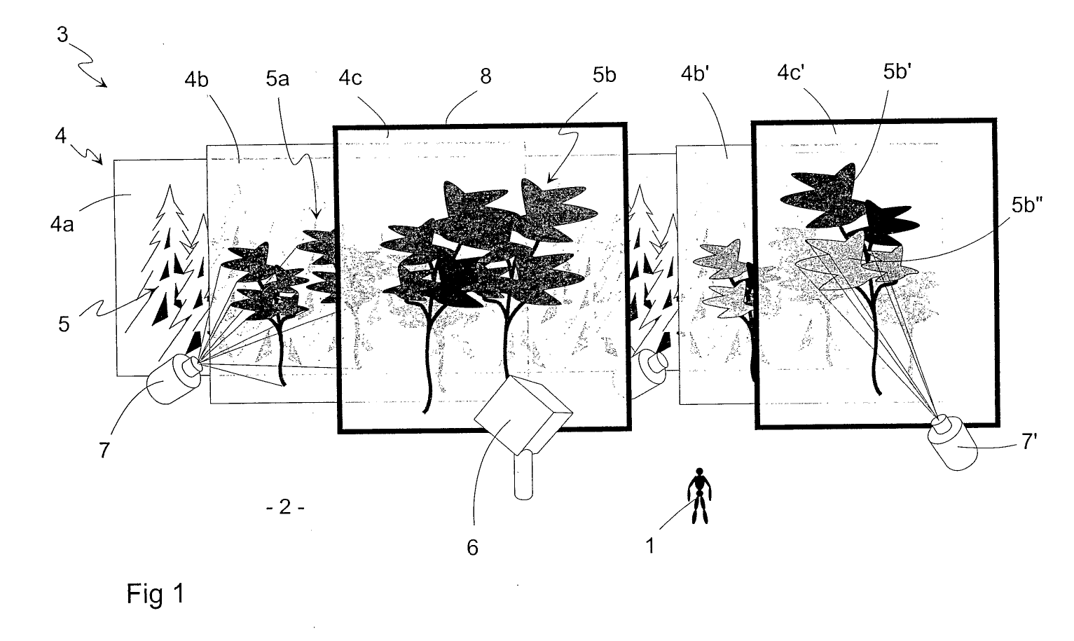

FIG. 1 shows a perspective view of one general arrangement having image planes at a distance from the spectator with visual sketches formed on them,

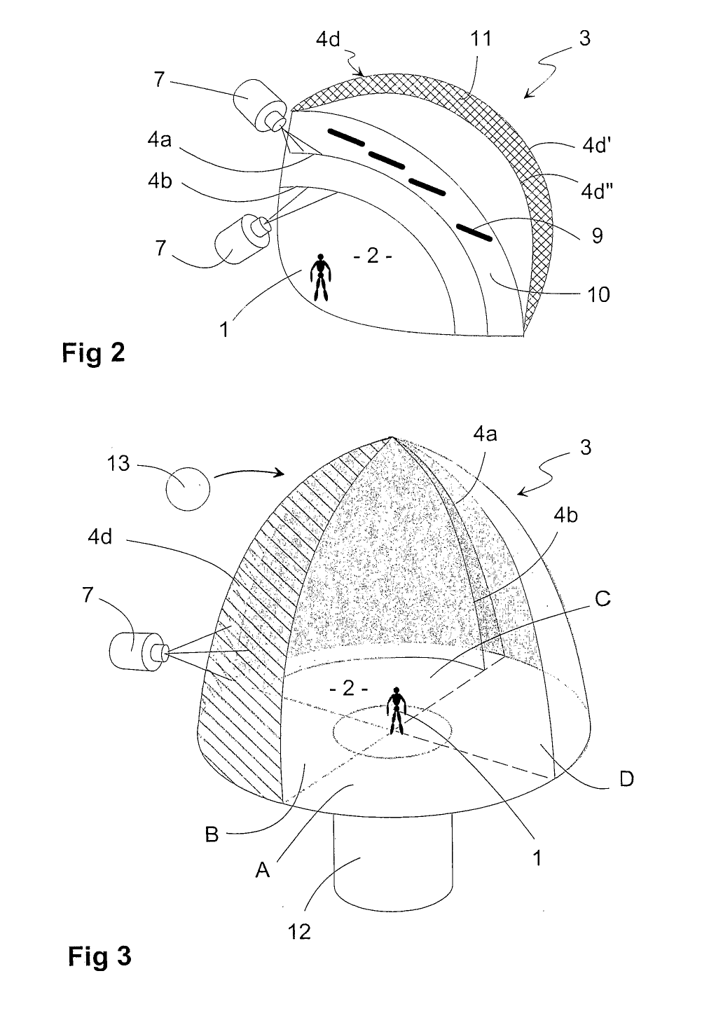

FIG. 2 shows a section of another, slightly different, spatial arrangement, and

FIG. 3 shows a perspective view of one spatial arrangement where image planes according to the invention have been compiled into elements of an essentially continuous wall/ceiling structure.

FIG. 1 illustrates how a three-dimensional spatial structure 2 is formed for viewing by spectator 1, with a visually detectable array of image planes 3. The image array 3 has planes 4a, 4b, 4c, 4b′, 4c′ physically separated from each other on which the images forming the visual composition can be projected for spectator 1 to view. According to the invention, separate visual sketches 5, 5a, 5b are projected onto the image planes 4a, 4b, 4c, 4b′, 4c′ in such a manner that they are at different distances from spectator 1 so that consequently, spectator 1 physically sees the image plane array 3 as three-dimensional. The three-dimensional view seen by the spectator's eyes and formed by his/her brain represents a virtual scenery because the scenery does not physically exist in the form that the spectator sees it. In addition to this virtual scenery, space 2 may have virtual details produced in a similar manner (not shown separately). Further, space 2 may naturally contain physically existing details, such as the piece of art 6 shown in the figure by way of example.

In this context, spectator 1 specifically refers to one or more persons physically present in space 2. Similarly, it should be noted that the term “plane” as used herein is as such deemed to also include other than purely planar surfaces on which the impression of an image can be formed. Therefore, the term also includes curved surfaces, separate holograms or their parts, projection objects of at least certain geometric thickness, such as smokescreens, and other such elements of the three-dimensional space 2 on which individual visual sketches 5, 5a, 5b can be formed.

FIG. 1 illustrates, by way of example, that a virtual scenery could as sketch elements 5, 5a contain trees that have been projected, using projectors 7, on planes 4a, 4b and 4b that are adjacent to each other when seen by spectator 1. Similarly, it is illustrated by way of example that one or more projection planes, for example the plane 4c closest to the spectator in an arrangement according to FIG. 1, has such a technical implementation that the sketch elements 5b are visible on it when formed as images, e.g. on an at least partially transparent LCD display. In FIG. 1, the technical difference of the LCD display is illustrated by the thick frame 8, which represents the as such known prior art technology required by the display control of LCD displays. Similarly, FIG. 1 illustrates that it is also possible to project onto such an image plane 4c′, which already, as such, is capable of showing the visual sketch 5b′, a projection by another projector 7′ or equivalent of another sketch 5b″ which in the case presented here is visible on image plane 4c′ on top of the sketch 5b′ shown in another manner.

Instead of, or in addition to, projection 7, 7′ and/or electronic display 8 it is of course possible to use any other method for introducing the visual sketch on the surface as a visual figure or image. In this context, the word “surface” also refers to other at least partially transparent media suitable for forming a visual sketch, such as mirrors, smoke or liquid screens as well as other such devices on which virtual sketch element figures can through external influence 7, 7′, 8 be formed in such a way that they are from the spectator's point of view visible on several consecutive planes which, as previously stated, refers to a means of display of both planar and other shapes. In addition to forming such a sketch on an at least partially transparent surface, the three-dimensional impression can within the framework of the invention be complemented by placing physically existing, i.e. predominantly tangible scenery elements 9 between the spaces 10 of planes 4a, 4b, 4c that are at different distances from the spectator, as illustrated in more detail in FIG. 2.

FIG. 2 further illustrates an arrangement where at least one plane element 4 has a double wall structure 4d. It is possible to introduce a suitable medium 11, such as smoke, a suitably coloured liquid or a solid net-like structure, between the walls 4d′, 4d″ located at the ends of the space of such a structure, allowing the structure of element 4 or the impression it creates to be totally altered. Such an element allows creating, for example, an artificial night-time ambience in space 2 while the other virtual scenery elements 5 . . . 5b″ stay either substantially the same or suitably adjusted to the mood. The night-time ambience can in this case be further enhanced by a picture of the moon, a starlit sky or similar projected onto the surface (not shown), whereas smoke blown through such a space 10 used as the ceiling structure can be used to create a virtual image of a cloud in the sly, for example.

The arrangement according to one embodiment of the invention is one where the nature of the virtual scenery observed by the spectator is affected by introducing one or more external influences on the planes. In addition to the as such known prior art LCD display mentioned above, one example of such external influence is a variable magnetic or electric field used to control the degree of transparency of the display and/or projection surface. Similarly, the properties of the surface can be influenced using, e.g., ultraviolet radiation in such a way that external sunlight automatically changes the circumstances in space 2 by changing the degree of transparency of a wall or ceiling element. Other examples of such external influences are, e.g., a change in temperature or even physical tension, which in certain types of glass structures changes the refraction of light and thus, also, the appearance of the virtual scenery projected onto them.

In addition to, or instead of, the above projectors 7, 7′, the devices for converting the virtual scenery elements 5 . . . 5b″ into visual form may also include a figure physically formed on the projection surface, the visibility of which can be separately activated or its appearance changed. In such a case, the activation preferably includes projecting onto the projection surface, or an element supporting such a surface, light, a charge or similar external influence that is either focused or altered in order to create the desired impression. Creating or changing the desired impression may also include the use of mirrors, preferably in such a way that the properties of a semi-transparent mirror are changed, e.g., in such a manner that the images 5 . . . 5b″ projected onto the mirror or visible on it are in different situations shown in different ways and/or in different places.

Preferably the image planes 4 . . . 4d according to the invention are at least partly projection surfaces, suitably such that the elements containing the surfaces are preferably made of self-cleaning glass, mirrors or similar substantially planar structures made of plastic and/or as such known at least partially transparent display devices of prior art. Such structures can then be used to form, for example, a spatial arrangement shown in FIG. 3 accommodating one or more spectators 1. The spatial element illustrated in FIG. 3 is then suitably a substantially closed space where spectator 1 can enter, e.g., using lift arrangement 12 in such a way that he/she preferably is in the centre of the closed spatial element that extends in all directions and gives spectator 1 a profoundly three-dimensional impression.

Such a spatial element or space 2 can then accommodate activities of prior art, known as such, for example a cafeteria, swimming pool, etc., surrounded by different virtual sceneries. These virtual sceneries are formed from compilations of image planes, only one of which is shown in FIG. 3 for the sake of clarity. References A . . . D mark different sectors on the floor of space 2, in which the wall-ceiling structure can for example illustrate different seasons in the form of virtual scenery and its supplementing structures and phenomena.

Thus, sector A (the walls of which are not illustrated in FIG. 3) could depict a summer scenery that may even include elements of the zoo, including animals and plants. In sector B, the same or different virtual scenery can be depicted in its autumnal state. Equally, in sector C, a winter scenery is artificially maintained, supported by wintry conditions projected onto surfaces 4a . . . 4c or depicted otherwise, with frozen trees, piles of snow etc., some of which may be genuine frozen elements, while sector D displays circumstances related to springtime.

Alternatively, or as a supplement, the different sectors may similarly depict different geographical areas. In addition to seasons of the year, space 2 in FIG. 3 can also depict different times of the day so that the suitably illuminating element 13 moving around the space can act both as the “the sun” and “the moon”, where the nature of the visible celestial body can be changed, not only with respect to its luminosity, but also by altering the degree of transparency of one of the projection planes 4a . . . 4d from non-transparent to transparent according to the time of day or month of the year to be displayed.

Even though the enclosed figures predominantly illustrate such embodiments where the spectator's field of vision is divided into sectors, it is obvious that the scope of the invention also includes such arrangements where the field of vision is divided in some other way or where the field of vision forms one continuum without visible divisions. The other embodiments are also included in the scope of an arrangement according to the invention within the framework of the enclosed patent claims. It should also be noted that the concept of “scenery” as used above not only includes geographic landscape but also other such visible entities, perceived to be extensive, where the aspect of a three-dimensional view is of pivotal importance for the impression created for the spectator. Similarly, the general arrangement according to the invention also allows displaying subjects other than scenery on one or more planes or surfaces, such as details depicting animals, factual information related to the subjects being displayed, or even commercial advertisements.

1. A method for displaying a three-dimensional virtual scenery to one or more spectators (1), characterized in that consecutive, visible scenery elements (5, 5a, 5b, 5b′, 5b″) are produced on consecutive, at least partially transparent planes (4, 4a, 4b, 4b′, 4c, 4c′, 4d, 4d′) and/or spaces (10) between such planes in such a way that the series of these images are visible to the spectator (1) as a three-dimensional impression of a virtual scenery.

2. A method according to patent claim 1, characterized in that the consecutive scenery elements (5, 5a, 5b, 5b′, 5b″) are formed by reflecting or projecting scenery element images on one or more planes (4, 4a, 4b, 4b′, 4c, 4c′, 4d, 4d′).

3. A method according to patent claim 1, characterized in that the consecutive scenery elements (5, 5a, 5b, 5b′, 5b″) are formed by taking scenery elements in physical form (9, 11) to spaces (10) between planes (4, 4a, 4b, 4b′, 4c, 4c′, 4d, 4d′) located at different distances from the spectator (1).

4. A method according to patent claim 1, characterized in that the nature of the visible virtual scenery is influenced by subjecting the planes (4, 4a, 4b, 4b′, 4c, 4c′, 4d, 4d′) to external influence such as preferably a variable electric field (8), radiation, change in temperature and/or physical tension that causes at least one property or parameter of the subject plane to be changed.

5. An arrangement for displaying a three-dimensional virtual scenery, characterized in that the arrangement includes several consecutive, at least partially transparent display or image planes (4, 4a, 4b, 4b′, 4c, 4c′, 4d, 4d′) as well as devices (7, 7′, 8) for producing visually detectable scenery elements (5, 5a, 5b, 5b′, 5b″) in visual form on these planes (4, 4a, 4b, 4b′, 4c, 4c′, 4d, 4d′) and/or between them.

6. An arrangement according to patent claim 5, characterized in that the devices for producing the scenery elements in visible form include projectors (7, 7′) or devices that allow the picture or image of the scenery element (5, 5a, 5b, 5b′, 5b″) to be projected onto the appropriate spot on a partially transparent plane (4, 4a, 4b, 4b′, 4c, 4c′, 4d, 4d′), preferably on a projection surface.

7. An arrangement according to patent claim 5, characterized in that the devices for producing the scenery elements in visible form include a figure (8) physically formed on one or more display and/or projection surfaces (4, 4a, 4b, 4b′, 4c, 4c′, 4d, 4d′), the visibility of which can be activated or its appearance changed by focusing or changing the light, charge or similar external influence extended to an element supporting such a surface (4, 4a, 4b, 4b′, 4c, 4c′, 4d, 4d′), or as such by changing the physical properties, such as tension, or display control signals of the element containing the projection and/or display surface.

8. An arrangement according to patent claim 5, characterized in that at least one display and projection device (4c) is an at least partially transparent electronically controlled display device (8), preferably a liquid crystal display.

9. An arrangement according to patent claim 5, characterized in that the image planes are projection surfaces, suitably so that the elements containing such surfaces (4, 4a, 4b, 4b′, 4c, 4c′, 4d, 4d′) are preferably self-cleaning glass, mirrors or similar substantially planar structures made of plastic and/or display structures containing a liquid crystal display (8).

10. An arrangement according to patent claim 5, characterized in that a spatial element has been formed of one or more elements including an image plane, preferably in such a way that one or more spectators (1) can be accommodated within the element.

11. A method according to patent claim 2, characterized in that the consecutive scenery elements (5, 5a, 5b, 5b′, 5b″) are formed by taking scenery elements in physical form (9, 11) to spaces (10) between planes (4, 4a, 4b, 4b′, 4c, 4c′, 4d, 4d′) located at different distances from the spectator (1).

12. A method according to patent claim 2, characterized in that the nature of the visible virtual scenery is influenced by subjecting the planes (4, 4a, 4b, 4b′, 4c, 4c′, 4d, 4d′) to external influence such as preferably a variable electric field (8), radiation, change in temperature and/or physical tension that causes at least one property or parameter of the subject plane to be changed.

13. A method according to patent claim 3, characterized in that the nature of the visible virtual scenery is influenced by subjecting the planes (4, 4a, 4b, 4b′, 4c, 4c′, 4d, 4d′) to external influence such as preferably a variable electric field (8), radiation, change in temperature and/or physical tension that causes at least one property or parameter of the subject plane to be changed.

14. An arrangement according to patent claim 6, characterized in that the devices for producing the scenery elements in visible form include a figure (8) physically formed on one or more display and/or projection surfaces (4, 4a, 4b, 4b′, 4c, 4c′, 4d, 4d′), the visibility of which can be activated or its appearance changed by focusing or changing the light, charge or similar external influence extended to an element supporting such a surface (4, 4a, 4b, 4b′, 4c, 4c′, 4d, 4d′), or as such by changing the physical properties, such as tension, or display control signals of the element containing the projection and/or display surface.

15. An arrangement according to patent claim 6, characterized in that at least one display and projection device (4c) is an at least partially transparent electronically controlled display device (8), preferably a liquid crystal display.

16. An arrangement according to patent claim 7, characterized in that at least one display and projection device (4c) is an at least partially transparent electronically controlled display device (8), preferably a liquid crystal display.

17. An arrangement according to patent claim 6, characterized in that the image planes are projection surfaces, suitably so that the elements containing such surfaces (4, 4a, 4b, 4b′, 4c, 4c′, 4d, 4d′) are preferably self-cleaning glass, mirrors or similar substantially planar structures made of plastic and/or display structures containing a liquid crystal display (8).

18. An arrangement according to patent claim 7, characterized in that the image planes are projection surfaces, suitably so that the elements containing such surfaces (4, 4a, 4b, 4b′, 4c, 4c′, 4d, 4d′) are preferably self-cleaning glass, mirrors or similar substantially planar structures made of plastic and/or display structures containing a liquid crystal display (8).

19. An arrangement according to patent claim 8, characterized in that the image planes are projection surfaces, suitably so that the elements containing such surfaces (4, 4a, 4b, 4b′, 4c, 4c′, 4d, 4d′) are preferably self-cleaning glass, mirrors or similar substantially planar structures made of plastic and/or display structures containing a liquid crystal display (8).

20. An arrangement according to patent claim 6, characterized in that a spatial element has been formed of one or more elements including an image plane, preferably in such a way that one or more spectators (1) can be accommodated within the element.
